(19) United States
(12) Patent Application Publication
(10) Pub. No.: US 2020/0207065 A1
(43) Pub. Date: Jul. 2, 2020

(54) DOUBLE-SIDED TAPE, METHOD FOR PRODUCING THE SAME AND ELECTRONIC DEVICE INCLUDING THE SAME

(71) Applicant: 3M INNOVATIVE PROPERTIES COMPANY, St. Paul, MN (US)

(72) Inventors: Hayoung Lee, Gyeonggi-do (KR); Seunghoon Jung, Gyeonggi-do (KR)

(21) Appl. No.: 16/643,610

(22) PCT Filed: Aug. 15, 2018
(86) PCT No.: PCT/IB2018/056134

§ 371 Date: Mar. 2, 2020

(30) Foreign Application Priority Data
Sep. 6, 2017 (KR) 10-2017-0113625

(51) Int. Cl. B32B 27/06; B32B 27/36; B32B 27/40; B32B 3/02; B32B 7/12

(52) U.S. Cl. CPC B32B 27/065; B32B 27/36; B32B 2457/202; B32B 3/02; B32B 7/12; B32B 27/40

(57) ABSTRACT

The present disclosure relates to a double-sided tape, a method for producing the same, and an electronic device including the same. Specifically, according to one embodiment of the present disclosure, a double-sided tape may be provided, which may include: a first group layer and a second group layer stacked sequentially in one direction, in which the first group layer includes a first outer adhesive layer and a first film layer, which are sequentially stacked in the one direction, and the second group layer includes a foam carrier layer, a second film layer, and a second outer adhesive layer, which are sequentially stacked in the one direction, in which one of the first film layer and the second film layer is a polyethylene layer.

### BACKGROUND

The present disclosure relates to a double-sided tape, a method for producing the same, and an electronic device including the same.

### BACKGROUND ART

In the production of electronic devices such as televisions, double-sided tapes have been used for effectively bonding the constituent parts of the televisions. When assembling an electronic device by attaching a liquid crystal display (LCD) panel to a guide frame using double-sided tape, stress is generated due to deformation of the assembly parts such as a guide frame, a display panel, and so on due to the external environment, and this stress may be directly transferred to the panel, damaging the arrangement of the liquid crystals in the panel. The light leakage (phenomenon in which the LCD screen shows blots) is caused as the liquid crystal arrangement changes due to this stress. When the double-sided tape used to attach the liquid crystal display (LCD) panel to the guide frame is cured, there is a risk that the stress will be transferred directly to the panel, damaging the arrangement of the elements within the panel. In addition, as the stress is applied to the panel, the light leakage (phenomenon in which the LCD screen shows blots) occurs. In order to prevent this, in recent years, in addition to a substrate formed as a film (i.e., film layer), a substrate formed as a foam having a porous property, that is, a foam carrier layer has been used. Since the foam carrier layer is formed of a rather flexible material rather than a rigid material, a double-sided tape containing a foam carrier layer may effectively prevent light leakage in the panel.

Meanwhile, in the process of producing the electronic devices, products having defects are discarded, but this raises problems such as resource waste and environmental pollution as well as an increase in economic loss. In addition, since the panel is very expensive, the manufacturing cost will be increased if the defective product is discarded with the panel included therein. Thus, expensive components such as panels should be separated from the defective products and reused (recycled). For reuse (recycle) of the panels, the double-sided tape is configured so that it is completely removed without leaving the adhesive on the surface of the panel when the panel is detached from the frame.

### SUMMARY

However, when the double-sided tape produced in consideration of recycle is continuously exposed to a harsh environment such as high temperature and high humidity, the adhesion is not maintained and allows part of the panel to be separated from the frame. Particularly, in the curved television, which is currently receiving increasing attention, the panel is more likely to be detached from the frame due to the difference in curvature between the panel and the frame.

In addition, when the panel is fixed with a double-sided tape in consideration of recycling thereof, an assembly gap is formed between the panel and the frame. However, the frame behind the panel is exposed through this assembly gap and seen by the user, and the frame exposed through the gap is perceived as a bezel by the user, resulting in a problem that the bezel appears to be wider.

Embodiments of the present disclosure have been proposed to solve the problems described above and accordingly, it is an object of the present disclosure to provide a double-sided tape which can be stably bonded to panels and frames even in a harsh environment of high temperature and high humidity.

Another object of the present disclosure is to provide a double-sided tape which can contribute to a smaller size of the bezel, by preventing the frame from being exposed through the assembly gap provided around the panel.

### Technical Solution

According to one aspect of the present disclosure, a double-sided tape may be provided, which may include a first group layer and a second group layer stacked sequentially in one direction, in which the first group layer includes a first outer adhesive layer and a first film layer, which are sequentially stacked in the one direction, and the second group layer includes a foam carrier layer, a second film layer, and a second outer adhesive layer, which are sequentially stacked in the one direction, in which one of the first film layer and the second film layer is a polyethylene layer.

### Advantageous Effects

Embodiments of present disclosure give the following effects. A double-sided tape is capable of keeping the adhesion between the panel and the frame stable even in harsh environment such as high temperature and high humidity.

In addition, the double-sided tape covers the frame supporting the back side of the panel, thus preventing the frame supporting the back side of the panel from being exposed through an assembly gap provided around the panel.

### BRIEF DESCRIPTION OF THE DRAWINGS

FIG. 1 is a perspective view conceptually showing an electronic device according to an embodiment of the present disclosure.

FIG. 2 is an exploded perspective view of the electronic device of FIG. 1.

FIG. 3 is a cross-sectional view taken along the line X-X′ of FIG. 1.

FIG. 4 is a cross-sectional view showing the double-sided tape of FIG. 3.

FIG. 5 is a conceptual view showing a curved-type electronic device according to an embodiment of the present disclosure.

FIG. 6 is a cross-sectional view taken along the line Y-Y′ of FIG. 5.

FIG. 7 is a cross-sectional view of an electronic device according to another embodiment of the present disclosure.

FIG. 8 is a cross-sectional view showing the double-sided tape of FIG. 7.

FIG. 9 illustrates the double-sided tape of FIG. 7 in wound state.

FIG. 10 is a conceptual view illustrating a process of producing a double-sided tape according to another embodiment of the present disclosure.

### DETAILED DESCRIPTION

Hereinafter, specific embodiments for implementing the concept of the present disclosure will be described in detail with reference to the drawings.

Further, in explaining the present disclosure, any specific explanation on a well-known related configuration or function deemed to obscure the gist of the present disclosure will be omitted.

The expressions used herein are only for describing certain exemplary embodiments, and not intended to limit the scope of the disclosure. Unless otherwise specified, a singular expression includes a plural expression.

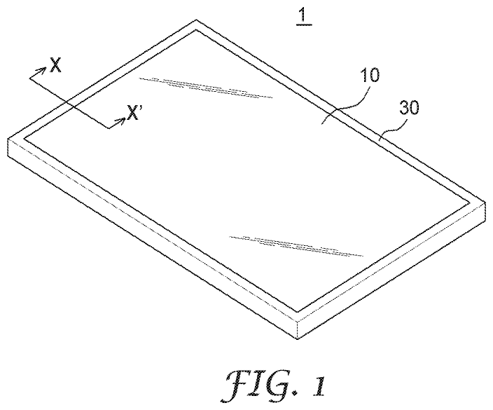

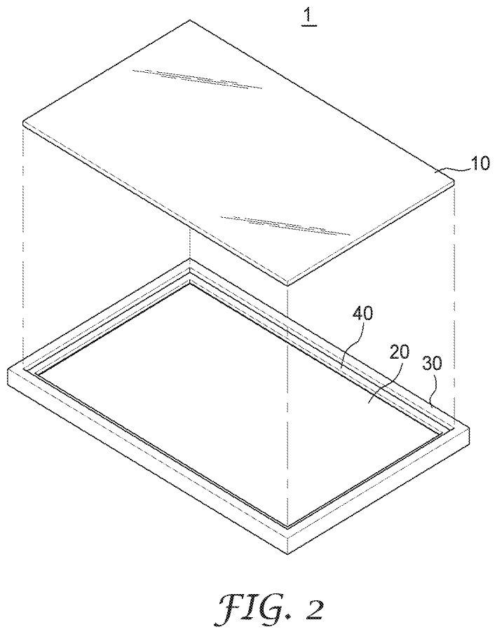

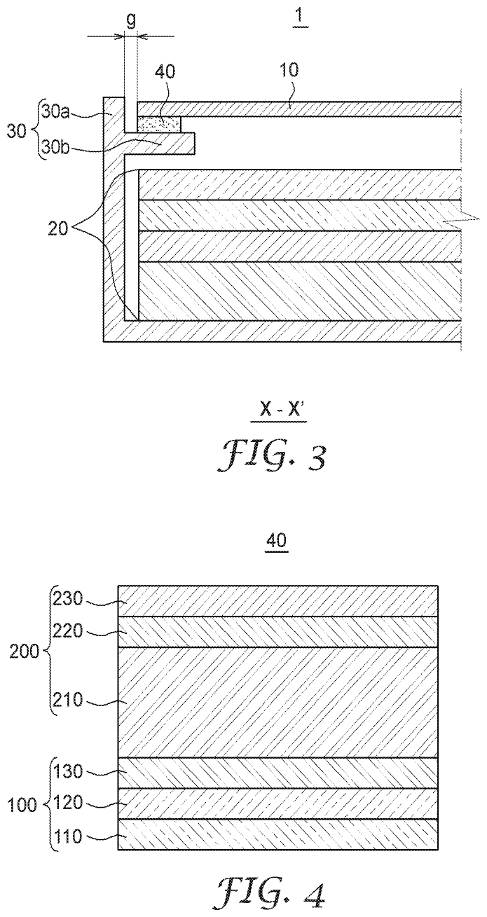

In an embodiment described below by referring to FIGS. 1 and 2, an electronic device 1 such as a TV screen may include a panel 10, which includes electric element having a transmittance varying in accordance with a voltage applied thereto and which is configured as an open cell type, a light source sheet 20 for emitting light toward the panel 10, a frame 30 including a sidewall 30a for supporting the panel 10 and the optical sheet 20, and a support 30b protruding inwardly from the sidewall 30a, and a double-sided tape 40 interposed between the support 30b and the panel 10 to adhere the panel 10 to the frame 30. Hereinafter, the structure of the double-sided tape 40 will be described with reference to FIGS. 3 and 4.

Throughout the description, the expressions ‘upper’, ‘lower’, ‘side’ and the like are described with reference to FIGS. 3 and 4, and it is to be noted that these may be expressed differently when the orientation of the corresponding object is changed.

Referring to FIGS. 3 and 4, the double-sided tape 40 may extend in a longitudinal direction along an edge of the panel 10 with a predetermined width w. While the drawings according to this embodiment exemplify that the upper surface (first surface) of the double-faced tape 40 is attached to the lower surface of the panel 10 and the lower surface (second surface) of the double-sided tape 40 is attached to the upper surface of the support portion 30b of the frame 30, thereby attaching the panel 10 to the frame 30, the present disclosure is not limited thereto. Accordingly, the first side of the double-sided tape 40 may be attached to the upper surface of the support 30b and the second side of the double-sided tape 40 may be attached to the lower surface of the panel 10.

The double-sided tape 40 includes a first group layer 100 and a second group layer 200 which are sequentially stacked from the lower direction. In one embodiment, the first group layer 100 may contact directly with the second group layer 200. The first group layer 100 may include a first outer adhesive layer 110, a first film layer 120 and an inner adhesive layer 130 which are sequentially stacked from the lower direction. In one embodiment, the first outer layer adhesive layer 110 may be directly adjacent to the first film layer 120 and the first film layer 120 may be directly adjacent to the inner adhesive layer 130. The second group layer 200 may include a foam carrier layer 210, a second film layer 220 and a second outer adhesive layer 230 which are sequentially stacked from the lower direction. In one embodiment, the foam carrier layer 210 may be directly adjacent to the second film layer 220 and the second film layer 220 may be directly adjacent to the second outer layer adhesive layer 230. In one embodiment, the foam carrier layer 210 may be directly adjacent to the inner adhesive layer 130. In addition, one of the first film layer 120 and the second film layer 220 may be a polyethylene layer and the other one of the first film layer 120 and second film layer 220 may be a film carrier layer that includes a polyethylene terephthalate (PET) film or a thermoplastic polyurethane (TPU) film.

The first outer adhesive layer 110, the first film layer 120 and the inner adhesive layer 130 of the first group layer 100; and the foam carrier layer 210, the second film layer 220 and the second outer adhesive layer 230 of the second group layer 200 may have the thicknesses as shown in Table 1 below.

TABLE 1

| | | Thickness (μm) |
|---|---|---|
| First group layer | First outer adhesive layer | 10~300 |
| | First film layer | 10~500 |
| | Inner adhesive layer | 10~300 |
| Second group layer | Second outer adhesive | 15~3000 |
| | Second film layer | 10~500 |
| | Film carrier layer | 10~300 |

The first outer adhesive layer 110, the second outer adhesive layer 230 and the inner adhesive layer 130 may be formed of a pressure sensitive adhesive (PSA) component. The PSA component may include, for example, acrylic polymer, silicone polymer, polyester-based polymer, rubber-based polymer, and polyurethane-based polymer, which may be used alone or in combination.

In addition, one or more of the first outer adhesive layer 110, the second outer adhesive layer 230 and the inner adhesive layer 130 may include an acrylic polymer having high transparency. The acrylic polymer is a polymer produced by the copolymerization of (meth)acrylic acid alkyl ester having 1 to 18 carbon atoms as a main monomer component, that is, by the compolymerization of a C1-C18 acrylate-based compound. This acrylic polymer may have a weight average molecular weight of 1,000,000 or greater. As used herein, “(meth)acrylate” refers to both acrylate polymer and (meth)acrylate polymer.

Examples of the C1-C18 acrylate compound may include methyl (meth)acrylate, ethyl (meth)acrylate, propyl (meth)acrylate, n-butyl (meth)acrylate, isobutyl (meth)acrylate, 2-ethylhexyl (meth)acrylate, n-octyl (meth)acrylate, isooctyl (meth)acrylate, lauryl (meth)acrylate, stearyl (meth)acrylate, isononyl (meth)acrylate, cyclohexyl (meth)acrylate, benzyl (meth)acrylate, methoxyethyl (meth)acrylate, ethoxyethyl (meth)acrylate, and phenoxyethyl (meth)acrylate. In addition, copolymers of these acrylate compounds and other monomers (for example, styrene-based monomer, olefin monomers, vinyl esters, cyano-group-containing monomers, amide-group-containing monomers, hydroxyl-group-containing monomers, acidic-group-containing monomers, epoxy-group-containing monomers, amino-group-containing monomers, carboxyl-group-containing monomers and the like) may be used.

In addition, in some embodiments of the present disclosure, one or more of the first outer adhesive layer 110, the second outer adhesive layer 230 and the inner adhesive layer 130 may have a glass transition temperature of −20 to 20° C.

The polyethylene layer may form one of the first film layer 120 and the second film layer 220. Throughout the description and the claims, ‘polyethylene layer’ is defined as a layer including all or part of polyethylene. This polyethylene layer may be stretched so that no remainder of the adhesive is left on the frame 30 or the panel 10 when the double-sided tape 40 is removed from the frame 30 or the panel 10. In addition, the polyethylene layer may be configured to have a predetermined stiffness. The double-sided tape 40 is not peeled off from the frame 30 or the panel 10 even in a harsh environment where high temperature and high humidity conditions are maintained.

The polyethylene layer may have a density of 0.500 g/cm³ or greater and 0.950 g/cm³ or less, a thickness of 10 μm or greater and 500 μm or less, a tensile load of 1 kpa or greater and 30 kpa or less, a modulus of 60 MPa or greater and 200 MPa or less, and an elongation of 100% or greater and 1500% or less. If the polyethylene layer has a tensile load of less than 60 MPa, there is a problem that the polyethylene layer may break during rework. Accordingly, the tensile load should be 60 MPa or greater. If the tensile load exceeds 200 MPa, rework may be difficult.

The film carrier layer may form the other one of the first film layer 120 and the second film layer 220. For example, when the first film layer 120 is a polyethylene layer, the second film layer 220 may be a film carrier layer. Regarding the film carrier layer, a sheet formed as a film, for example, a plastic material formed as a film may be used as the film carrier layer, in which the plastic material may be one or more selected from thermoplastic polyurethane; polyethylene terephthalate; polycarbonate; norbornene resin; olefin polymer; and triacetyl cellulose (TAC), which may be combined by blending. In addition, the film carrier layer is one or more selected from a high transparency polyethylene terephthalate film, a black opaque film carrier layer, or a combination thereof.

The foam carrier layer 210 is a porous sheet obtained by foaming a raw resin. The foam carrier layer 210 may be thicker than the first film layer 120 and the second film layer 220. The foam carrier layer 210 may improve the impact resistance of the double-sided tape and prevent light leakage. In addition, the foam carrier layer 210 may prevent generation of the wrinkles during the roll operation. The foam carrier layer 210 may be a foam such as one or more selected from polystyrene, polyurethane, polyvinyl chloride, acrylate, olefin, and rubber, which may be combined by blending.

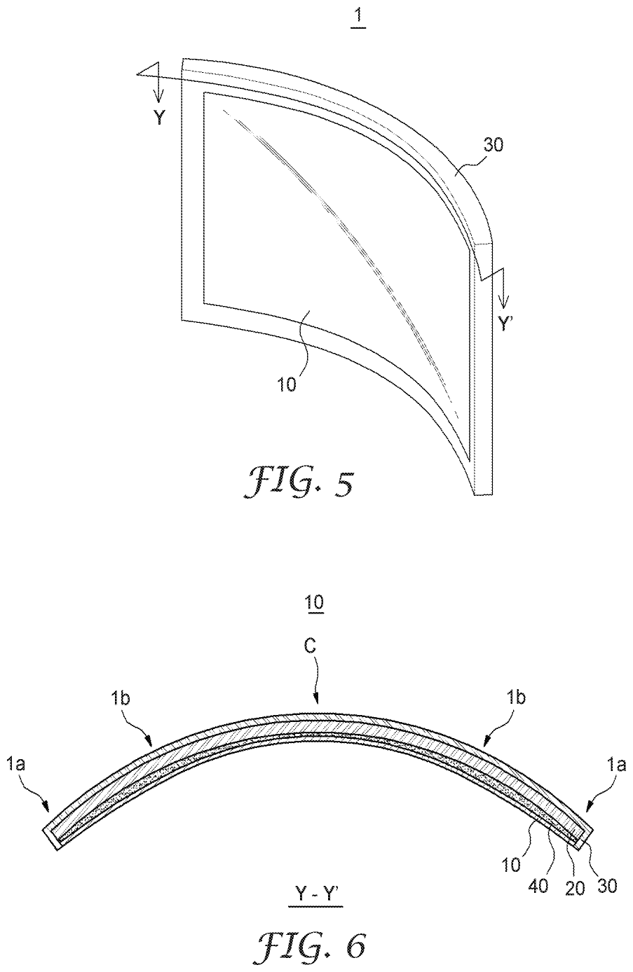

Hereinafter, the effect of a double-sided tape 40 having the stack structure described above will be described with reference to FIGS. 5 and 6.

The curved electronic device 1 has been introduced recently, in which the frame and the panel are produced with a predetermined curvature and attached to each other.

However, as shown FIGS. 5 and 6, the curvatures of the frame and the panel are provided such that the frame has a curvature almost equal to the processed curvature with little variations of the curvature throughout the panel, while the panel including glass, crystal, etc. have an inconsistent curvature. For example, the center portion c and the left and right edge portions 1a of the panel have a curvature less than the processed curvature, and the portion 1b between the center portion and the left edge portion and the portion 1b between the center portion and the right edge portion have a curvature greater than the processed curvature. Therefore, at the portion 1b between the center portion and the edge portion, the double-sided tape 40 is subjected to the stretching force in the thickness direction.

The conventional double-sided tape has a problem that if the double-sided tape is subjected to a stretching force in the thickness direction in a harsh environment of high temperature and high humidity, the double-sided tape comes undone as it is not able to maintain adhesion between the panel and frame. However, the double-sided tape 40 according to one embodiment of the present disclosure can withstand the stretching force in the direction of thickness and maintain adhesion between the panel 10 and the frame 30 even in the harsh environments of high temperature and high humidity.

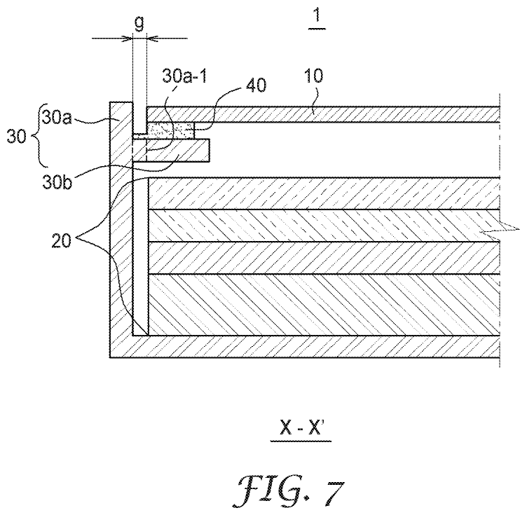

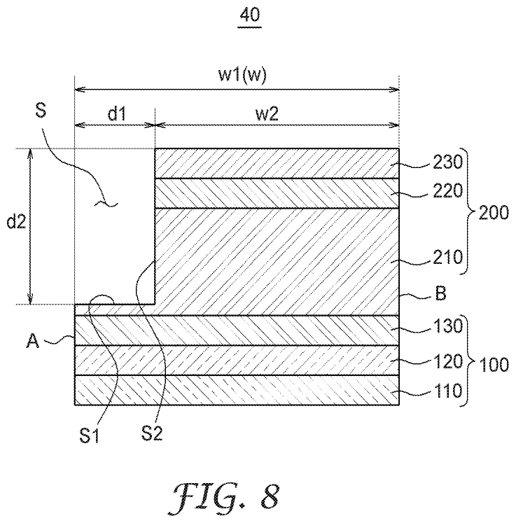

Meanwhile, a predetermined gap g may be formed between the edge of the panel 10 and the sidewall 30a of the frame 30 for assembling the panel 10. The gap g serves as an assembly tolerance. However, according to one embodiment of the present disclosure as described above, a portion of the support 30b of the frame 30 can be exposed through the gap g to be visible to the user. The exposed support 30b can be perceived by the user as a bezel. Accordingly, another embodiment of the present disclosure described below is presented to solve this problem. Hereinafter, another embodiment of the present disclosure is described with reference to FIGS. 7 and 8.

In describing another embodiment of the present disclosure, the differences from the one embodiment already described above are mainly described, and the same description and reference numerals are referred to the above.

Referring to FIGS. 7 to 9, likewise the one embodiment described above, the double-sided tape 40 has a width w of 1.0 mm or greater and 10.0 mm or less, and may extend in a longitudinal direction along the edge of the panel 10, and includes a first group layer 100 and a second group layer 200 which are sequentially stacked from the lower direction.

The width w1 of the first group layer 100 may be substantially the same as the width w of the entire double-sided tape 40. In addition, at least a portion of the second group layer 200 in the thickness direction may have a width w2 that is less than the width w1 of the first group layer 100. Accordingly, the second group layer 200 may be formed such that the second group layer 200 is recessed from the upper surface thereof by a first distance d1 in the thickness direction, and recessed from the one side surface A by a second distance d2 in the width direction (left and right directions in FIGS. 7 and 8). In other words, a stepped portion s may be formed on one side in the width direction of the double-sided tape 40, and the stepped portion s may have a stepped bottom portion s1 recessed from an upper surface of the second group layer 200 by the first distance d1, and a stepped side portion s2 recessed from the one side surface A by the second distance d2 in the width direction of the double-faced tape 40. The stepped portion s may be formed such that the first distance d1 is equal to or greater than the gap g, and the second distance d2 is equal to or less than the thickness of the second group layer 200. The first distance d1 of the stepped bottom portion s1 may be 0.1 mm or greater and 3.0 mm or less. The ratio (d1/w1) may have a range from 10% to 90%. However, the values of d1 and w1 may be changed according to the design to be applied and have the maximum and minimum values within a processible range.

In addition, the first group layer 100 and the second group layer 200 may be disposed in parallel on the other side B in the width direction.

The double-sided tape 40 may extend into the space under the gap g between the edge of the panel 10 and the sidewall 30a to cover the support 30a-1 under the gap. In other words, the stepped bottom portion s1 may cover at least a portion of the support 30a-1 under the gap. In addition, since the first distance d1 of the stepped bottom portion s1 has a size of the gap g or greater, when the side surface A in the width direction of the double-sided tape 40 is disposed in contact with the sidewall 30a of the frame 30, the stepped bottom portion s1 covers all of the support 30a-1 under the gap so that the support 30a-1 under the gap can be blocked from being exposed through the gap g.

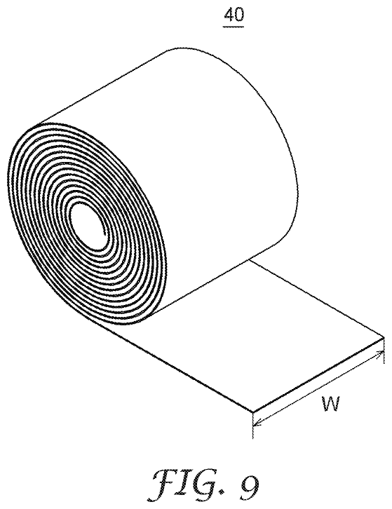

In addition, according to another embodiment of present disclosure, the second film layer 120 of the first group layer 100 may be a polyethylene layer. When the stepped portion s is formed on the double-sided tape 40, the double-sided tape 40 has a very thin thickness at the stepped bottom portion s1, in which case the double-sided tape 40 may be crushed or damaged during the roll operation. However, when the second film layer 120 is formed of a polyethylene layer having a predetermined stiffness, the double-sided tape 40 may be prevented from being crushed or damaged in the course of the roll operation, even when the stepped portion s is formed along one side in the width direction of the double-side tape 40. Thus, the double-sided tape 40 has a thin thickness and has a stepped portion s on one side in the width direction, but can be wound along the longitudinal direction without being crushed or damaged (FIG. 9).

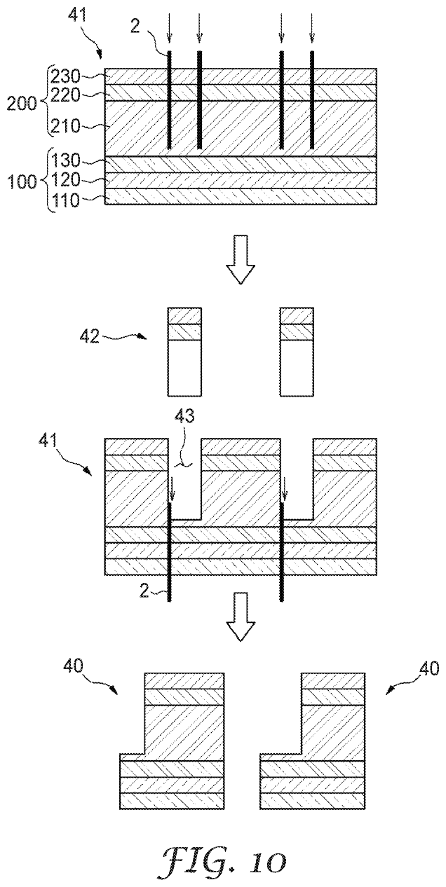

Hereinafter, a method for producing the double-sided tape 40 according to another embodiment of the present disclosure will be described with reference to FIG. 10.

Referring to FIG. 10, a bulk stack 41 may be prepared in which the first group layer 100 and the second group layer 200 are sequentially stacked. The first group layer 100 may include a first outer adhesive layer 110, a first film layer 120 and an inner adhesive layer 130 which are sequentially stacked from the lower direction. The second group layer 200 may include a foam carrier layer 210, a second film layer 220 and a second outer adhesive layer 230 which are sequentially stacked from the lower direction. In addition, the first film layer 120 may be a polyethylene layer, and the second film layer 220 may be a film carrier layer including a polyethylene terephthalate film or a thermoplastic polyurethane film.

In preparing such a bulk stack, conventionally, the thermoplastic polyurethane layer is provided as the first film layer 120. However, since the thermoplastic polyurethane layer is soft, it is difficult to bond the thermoplastic polyurethane layer (first film layer) and the foam carrier layer. In other words, since a soft thermoplastic polyurethane layer is conventionally provided as the first film layer, it is impossible to produce a bulk stack by way of separately preparing a thermoplastic polyurethane layer and a foam carrier layer and then and bonding the same. Accordingly, the thermoplastic polyurethane layer is prepared first, and then the foam carrier layer is directly prepared and applied on the thermoplastic polyurethane layer by coating the foam on the thermoplastic polyurethane layer. However, this foam method has a problem of high manufacturing cost.

However, when a polyethylene layer having a predetermined stiffness is provided as the first film layer 120 as in the embodiments of the present disclosure, it is possible to produce a bulk stack by separately preparing the first film layer 120 and the foam carrier layer 210 and then bonding the same. Therefore, there is an effect that the bulk stack can be produced with a low cost and simple process.

The bulk stack 41 prepared by the above process is cut by a plurality of cutters 2 in the cutting step (cutting step). In this cutting step, only the portion corresponding to the second group layer 200 is cut off from the bulk stack 41, and the first group layer 100 portion is not cut off. In other words, in the cutting step, the second group layer 200 may be cut by a cutter 2 having a predetermined width to form a cutoff portion 42, and in such cutting step, a plurality of cutoff portions 42 may be provided at predetermined intervals. The cutoff portion 42 may have the same width as the first distance d1 which is the length of the stepped bottom portion s1, and may have the same thickness as the second distance d2 which is the length of the stepped side portion s2. In addition, a plurality of cutoff portions 42 may be cut off at once.

The cutoff portion 42 is removed from the bulk stack 41, and a plurality of cut holes 43 are formed in the bulk stack 41 (cut hole forming step). The cut hole 43 may have the same width as the first distance d1 and the same depth as the second distance d2.

This cut hole 43 forms the stepped portion s of the double-sided tape 40.

The bulk stack 41 after the cutting step may be slitted by the cutter 2 (slitting step). In the slitting step, the first group layer 100 is cut along the side surface (left side surface in FIG. 10) of the one side of one of the plurality of cut holes 43, and is cut along the side surface (left side surface in FIG. 10) of the one side of an adjacent cut hole. The cut and slitted bulk stack 41 each forms the double-sided tape 40. In other words, the bulk stack 41 is cut along the surface of one side (left side in FIG. 7) of the cut hole to form one side surface of the double-sided tape 40, and the bulk stack 41 is cut along the surface of one side (left side in FIG. 7) of an adjacent cut hole to form the other side surface of the double-sided tape 40. The double-sided tape 40 after the slitting step can be subjected to a rolling process.

While the drawings according to the present embodiment exemplify that the slitting step is performed after the cut hole forming step, the present disclosure is not limited thereto. For example, the cutoff portion 42 may be removed from the bulk stack 41 after the cutting step and the slitting step are consecutively performed by the cutter 2.

The following is a list of embodiments of present disclosure.

Item 1 is a double-sided tape, including a first group layer and a second group layer stacked sequentially in one direction, in which the first group layer includes a first outer adhesive layer and a first film layer, which are sequentially stacked in the one direction, and the second group layer includes a foam carrier layer, a second film layer, and a second outer adhesive layer, which are sequentially stacked in the one direction, in which one of the first film layer or the second film layer is a polyethylene layer.

Item 2 is a double-sided tape, in which the first group layer further includes an inner adhesive layer stacked on the first film layer for adhesion with the second group layer.

Item 3 is a double-sided tape, in which the other one of the first film layer and the second film layer is formed of a polyethylene terephthalate film or a thermoplastic polyurethane film.

Item 4 is a double-sided tape, in which the polyethylene layer has a density of 0.500 g/cm or greater and 0.950 g/cm or less.

Item 5 is a double-sided tape, in which the polyethylene layer has a thickness of 50 μm or greater and 500 μm or less.

Item 6 is a double-sided tape, in which the polyethylene layer has a tensile load of 1 kpa or greater and 30 kpa or less.

Item 7 is a double-sided tape, in which the polyethylene layer has a modulus of 60 MPa or greater and 200 MPa or less.

Item 8 is a double-sided tape, in which the polyethylene layer has an elongation of 100% or greater and 1500% or less.

Item 9 is a double-sided tape, in which the double-sided tape has a width of 1.0 mm or greater and 10.0 mm or less.

Item 10 is a double-sided tape, in which the double-sided tape is configured to be wound along a longitudinal direction.

Item 11 is a double-sided tape, in which at least a portion of the second group layer has a narrower width than that of the first group layer so that a stepped portion is formed on one side of the double-sided tape.

Item 12 is an electronic device, including: the double-sided tape described in the proceeding items; a panel; and a frame extending along an edge of the panel, in which the frame includes: a sidewall disposed apart from an edge of the panel; and a support disposed on a lower side of the panel and protruding in an inward direction from the sidewall to support the panel, in which the double-sided tape is interposed between the support and the panel to bond the support to the panel.

Item 13 is an electronic device, in which the one side of the double-sided tape is opposite the sidewall of the frame.

Item 14 is an electronic device, in which the one side of the double-sided tape contacts the sidewall of the frame.

Item 15 is an electronic device, in which the double-sided tape extends to a lower side of the gap between the edge of the panel and the sidewall to cover the support.

Item 16 is a method for producing a double-sided tape, including: sequentially stacking a first group layer and a second group layer; a cutting step of cutting the second group layer to form a plurality of cutoff portions; a cut hole forming step of removing the cutoff portion from the second group layer to form a plurality of cut holes in the second group layer; and a slitting step of cutting the first group layer along one side surface of one of the plurality of cut holes and cutting the first group layer along one side surface of the cut hole adjacent to the one cut hole to form both ends of the double-sided tape, in which the cutoff portion has a thickness equal to or less than the thickness of the second group layer.

Item 17 is a method for producing a double-sided tape, in which the step of sequentially stacking includes: preparing the first group layer and the second group layer separately from each other; and bonding the first group layer and the second group layer to each other.

Although the double-sided tape, the method for producing the same, and the electronic apparatus including the same according to the embodiments of the present disclosure have been described by referring to specific embodiments, these are merely certain examples to illustrate the present disclosure, and the present disclosure is not limited thereto, and should be interpreted as having the broadest scope according to the basic idea disclosed herein. Those skilled in the art will be able to combine and/or substitute the disclosed embodiments to effect a pattern of a shape that has not been stated herein, but this also does not depart from the scope of the present disclosure. Further, it will be apparent to those skilled in the art that various changes and modifications may be readily made without departing from the idea and scope of the invention as defined by the appended claims.

Description of Reference Numerals

| | |
|---|---|
| 1: Electronic device | 10: Panel |
| 20: Optical Sheet | 30: Frame |
| 40: Double-sided tape | 41: Bulk stack |
| 42: Cutoff portion | 43: Cut hole |
| 100: First group layer | |
| 110: First outer adhesive layer | 120: First film layer |
| 130: Inner adhesive layer | 200: Second group layer |
| 210: Foam carrier layer | 220: Second film layer |
| 230: Second outer adhesive layer | |

1. A double-sided tape, comprising:
a first group layer; and
a second group layer, which are stacked sequentially in one direction,
wherein the first group layer comprises a first outer adhesive layer and a first film layer sequentially stacked in the one direction,
the second group layer comprises a foam carrier layer, a second film layer and a second outer adhesive layer sequentially stacked in the one direction, and
one of the first film layer and the second film layer is a polyethylene layer.

2. The double-sided tape of claim 1, wherein the first group layer further comprises an inner adhesive layer stacked on the first film layer for adhesion with the second group layer.

3. The double-sided tape of claim 1, wherein the other one of the first film layer and the second film layer is formed of a polyethylene terephthalate (PET) film or a thermoplastic polyurethane (TPU) film.

4. The double-sided tape of claim 1, wherein the polyethylene layer has a density of 0.500 g/cm or greater and 0.950 g/cm or less.

5. The double-sided tape of claim 1, wherein the polyethylene layer has a thickness of 10 μm or greater and 500 μm or less.

6. The double-sided tape of claim 1, wherein the polyethylene layer has a tensile load of 1 kpa or greater and 30 kpa or less.

7. The double-sided tape of claim 1, wherein the polyethylene layer has a modulus of 60 MPa or greater and 200 MPa or less.

8. The double-sided tape of claim 1, wherein the polyethylene layer has an elongation of 100% or greater and 1500% or less.

9. The double-sided tape of claim 1, wherein the double-sided tape has a width of 1.0 mm or greater and 10.0 mm or less.

10. The double-sided tape of claim 1, wherein the double-sided tape is configured to be wound along a longitudinal direction.

11. The double-sided tape of claim 1, wherein at least a portion of the second group layer has a narrower width than that of the first group layer so that a stepped portion is formed on one side of the double-sided tape.

12. An electronic device, comprising:
the double-sided tape of claim 11;
a panel; and
a frame extending along an edge of the panel,
wherein the frame comprises:
a sidewall disposed apart from an edge of the panel; and
a support disposed on a lower side of the panel and protruding in an inward direction from the sidewall to support the panel,
wherein the double-sided tape is interposed between the support and the panel to bond the support to the panel.

13. The electronic device of claim 12, wherein the one side of the double-sided tape is opposite the sidewall of the frame.

14. The electronic device of claim 13, wherein the one side of the double-sided tape contacts the sidewall of the frame.

15. The electronic device of claim 12, wherein the double-sided tape extends to a lower side of the gap between the edge of the panel and the sidewall to cover the support.

16. A method for producing a double-sided tape, comprising:
sequentially stacking a first group layer and a second group layer;
a cutting step of cutting the second group layer to form a plurality of cutoff portions;
a cut hole forming step of removing the cutoff portions from the second group layer to form a plurality of cut holes in the second group layer; and
a slitting step of cutting the first group layer along one side surface of one of the plurality of cut holes and cutting the first group layer along one side surface of a cut hole adjacent to the one cut hole to form both ends of the double-sided tape,
wherein the cutoff portion has a thickness equal to or less than the thickness of the second group layer.

17. The method for producing a double-sided tape of claim 16, wherein the step of sequentially stacking comprises:
preparing the first group layer and the second group layer separately from each other; and
bonding the first group layer and the second group layer to each other.

18. The method for producing a double-sided tape of claim 16, wherein the first group layer comprises a first outer adhesive layer and a first film layer sequentially stacked in the one direction, the second group layer comprises a foam carrier layer, a second film layer and a second outer adhesive layer sequentially stacked in the one direction, and one of the first film layer and the second film layer is a polyethylene layer.
